(19) United States
(12) Patent Application Publication
(10) Pub. No.: US 2013/0155967 A1
(43) Pub. Date: Jun. 20, 2013

(54) WIRELESS COMMUNICATION SYSTEM WITH INTERFERENCE PROVISIONING AND METHOD OF OPERATION THEREOF

(71) Applicants: Inyup Kang, San Diego, CA (US); Hyukjoon Kwon, San Diego, CA (US); Jungwon Lee, San Diego, CA (US); Junghyun Bae, San Diego, CA (US)

(72) Inventors: Inyup Kang, San Diego, CA (US); Hyukjoon Kwon, San Diego, CA (US); Jungwon Lee, San Diego, CA (US); Junghyun Bae, San Diego, CA (US)

(73) Assignee: SAMSUNG ELECTRONICS CO., LTD., Gyeonggi-Do (KR)

(21) Appl. No.: 13/561,881

(22) Filed: Jul. 30, 2012

Related U.S. Application Data
(60) Provisional application No. 61/576,349, filed on Dec. 15, 2011.

(51) Int. Cl. H04W 72/04; H04W 4/00

(52) U.S. Cl. 370/329; 370/328

(57) ABSTRACT

A method of operation of a wireless communication system includes: transmitting from a serving eNodeB for conveying a desired input signal to a first user electronics; transmitting from a neighbor eNodeB for conveying the desired input signal to a second user electronics and broadcasting an interference input signal toward the first user electronics;

activating a request additional parametric information module in the serving eNodeB for responding to the first user electronics; and transferring additional parametric information from the serving eNodeB for negating the interference input signal in the first user electronics.

### CROSS-REFERENCE TO RELATED APPLICATION

This application claims the benefit of U.S. Provisional Patent Application Ser. No. 61/576,349 filed Dec. 15, 2011, and the subject matter thereof is incorporated herein by reference thereto in its entirety.

### TECHNICAL FIELD

The present invention relates generally to a wireless communication system, and more particularly to a system for managing interference in a wireless communication system.

### BACKGROUND ART

The next generation cellular system, where the cell size is getting smaller so that inter-cell interference becomes a critical issue in terms of packet error performance, is in the process of deployment. In addition, since both pico-cell and femto-cell services were recently launched, the interference signal from these local cells has also become a major source to degrade the performance for the desired signal. In case of a point-to-point communication where a single transmitter sends a signal to the designated receiver, there is a protocol between the serving transmit/receive point and the user electronics (UE) so that they can share systematic parameters, such as modulation-and-coding scheme (MCS), handshake signals (ACK/NACK) and control information, that is needed for decoding the desired signal.

In normal operation, cellular systems operate over multiple transmit/receive points as the user electronics moves along a given path. While moving among the multiple transmit/receive points, any non-selected transmit/receive point can cause inter-cell interference signals to prevent the desired signal from being decoded correctly. It is essential to mitigate the inter-cell interference in order to maintain stable communication qualities and prevent dropped calls.

There have been many attempts to mitigate the inter-cell interference. Their corresponding performances for decoding the desired signal are mainly determined by the amount of interference signal information and by its proper utilization for decoding the desired signal. Any performance limitation highly depends on the magnitude of signal-to-interference ratio (SIR) as well as the MCSs of desired and interference signals.

Thus, a need still remains for a wireless communication system with interference provisioning. In view of the explosive growth of wireless communication devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a wireless communication system including: transmitting from a serving eNodeB for conveying a desired input signal to a first user electronics; transmitting from a neighbor eNodeB for conveying the desired input signal to a second user electronics and broadcasting an interference input signal toward the first user electronics; activating a request additional parametric information module in the serving eNodeB for responding to the first user electronics; and transferring additional parametric information from the serving eNodeB for negating the interference input signal in the first user electronics.

The present invention provides a wireless communication system, including: a serving eNodeB for conveying a desired input signal; a neighbor eNodeB for broadcasting an interference input signal toward the serving eNodeB; and a request additional parametric information module in the serving eNodeB activated for receiving the desired input signal and the interference input signal includes additional parametric information transferred from the serving eNodeB for negating the interference input signal in a first user electronics.

Certain embodiments of the invention have other steps or elements in addition to or in place of those mentioned above. The steps or element will become apparent to those skilled in the art from a reading of the following detailed description when taken with reference to the accompanying drawings.

### BRIEF DESCRIPTION OF THE DRAWINGS

FIG. 1 is a hardware block diagram of a wireless communication system in a first embodiment of the present invention.

FIG. 2 is a functional block diagram of an application of the wireless communication system.

FIG. 3 is a functional block diagram of an application of the wireless communication system utilizing the joint iterative detection and decoding of FIG. 1.

FIG. 4 is a flow chart of a method of operation of the wireless communication system of FIG. 1.

FIG. 5 is a flow chart of a method of operation of the wireless communication system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGS. is arbitrary for the most part. Generally, the invention can be operated in any orientation.

Where multiple embodiments are disclosed and described having some features in common, for clarity and ease of illustration, description, and comprehension thereof, similar and like features one to another will ordinarily be described with similar reference numerals. The same numbers are used in all the drawing FIGS. to relate to the same elements. The embodiments have been numbered first embodiment, second embodiment, etc. as a matter of descriptive convenience and are not intended to have any other significance or provide limitations for the present invention.

The term “module” referred to herein can include software, hardware, or a combination thereof. For example, the software can be machine code, firmware, embedded code, and application software. Also for example, the hardware can be circuitry, processor, computer, integrated circuit, integrated circuit cores, a pressure sensor, an inertial sensor, a micro-electromechanical system (MEMS), passive devices, or a combination thereof

The term “eNodeB” as referred to herein is defined to be the transmit/receive device that represents the electronic communication node that couples the user electronics (UE) to the network infrastructure of the communication network. As an example the eNodeB can be a communication source such as a cell tower, a wireless local area network (Wi-Fi) hotspot, a pico-cell or a femto-cell. The phrase “backhaul channels” referred to herein is defined to be the structure and network that interconnects the eNodeBs. The backhaul channels can include microwave systems, satellites, servers, interconnect media, switches, and storage that provides support for information transfer to the user electronics. The phrase “serving eNodeB” as referred to herein is defined to be the transmit/receive point that is communicatively coupled to a specific user electronics for intentional transfer of information. The phrase “neighbor eNodeB” as referred to herein is defined to be the transmit/receive point that is located in an adjacent space and is not communicatively coupled to the specific user electronics for intentional transfer of information.

It has been discovered that the UE can determine its capability to decode the desired signal by estimating or receiving from the serving eNodeB systematic parameters such as signal to noise ratio (SNR), signal to interference ratio (SIR), its own modulation-and-coding scheme (MCS), interference MCS, fading channel qualities or any other parameters. Based on its determined capability, the UE should specify whether or not it is necessary to request additional interference information from the neighbor eNodeB. If needed, it also specifies what information should be included in an inquiry to the serving eNodeB and subsequently the neighbor eNodeB through backhaul channels.

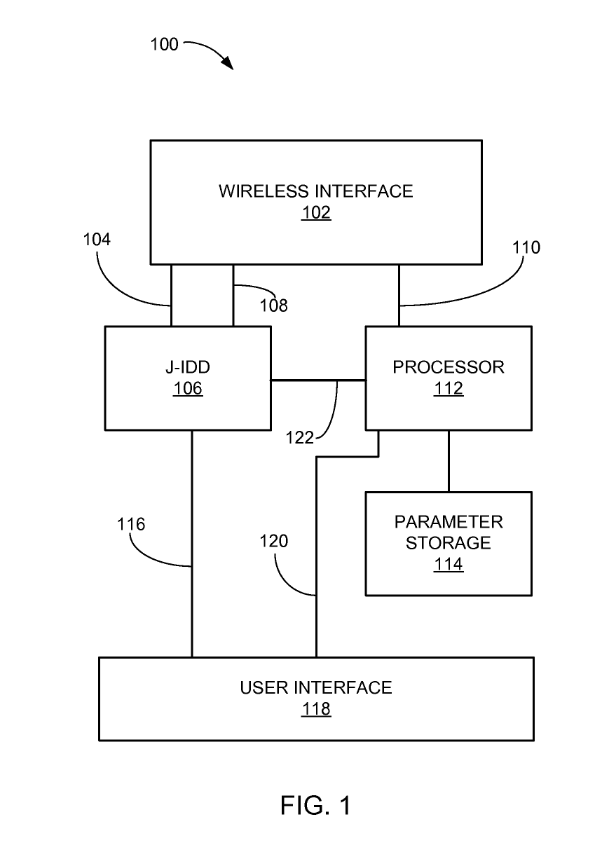

Referring now to FIG. 1, therein is shown a hardware block diagram of a wireless communication system 100 in a first embodiment of the present invention. The hardware block diagram of the wireless communication system 100 depicts a wireless interface 102 for coupling a desired input signal 104 to a joint iterative detection and decoding module 106. The wireless interface 102 can also couple an interference input signal 108 to the joint iterative detection and decoding module 106.

A control interface 110 couples the wireless interface 102 to a control processor 112. The control processor is also coupled to the joint iterative detection and decoding module 106 for monitoring the progress of the decoding of the desired input signal 104. The control processor 112 can be coupled to a parameter storage module 114, such as a random access memory or a register array, for maintaining key parameters associated with the decoding of the desired input signal 104.

A desired decoded signal 116 can be coupled between the joint iterative detection and decoding module 106 and a user interface module 118. The user interface module 118 can provide control information and user preferences to the control processor 112 through a control bus 120.

During operation of the wireless interface 102 the joint iterative detection and decoding module 106 can attempt to optimize the decoding of the desired input signal 104 by analyzing the interference input signal 108. If the joint iterative detection and decoding module 106 has difficulty in negating the effects of the interference input signal 108, the joint iterative detection and decoding module 106 can request the control processor 112 to solicit additional parametric information from the coupled eNodeB (not shown). The additional parametric information can include the modulation-and-coding scheme (MCS), the handshake signals (ACK/NACK), magnitude of signal-to-interference ratio (SIR), the signal to noise ratio (SNR), and control information for the neighbor eNodeB (not shown).

The mechanism by which the control processor 112 and the wireless interface 102 can request additional control parameters is the subject of this invention. It has been discovered that the joint iterative detection and decoding module 106 can greatly improve the ability of the wireless communication system 100 to decode the desired input signal 104. It has also been discovered that the control processor 112 can request additional support from the network infrastructure (not shown) that will extend the ability of the joint iterative detection and decoding module 106 to negate the effects of the interference input signal 108. Any additional parametric information can be loaded into the joint iterative detection and decoding module 106 by the control processor 112 through a control parameter bus 122.

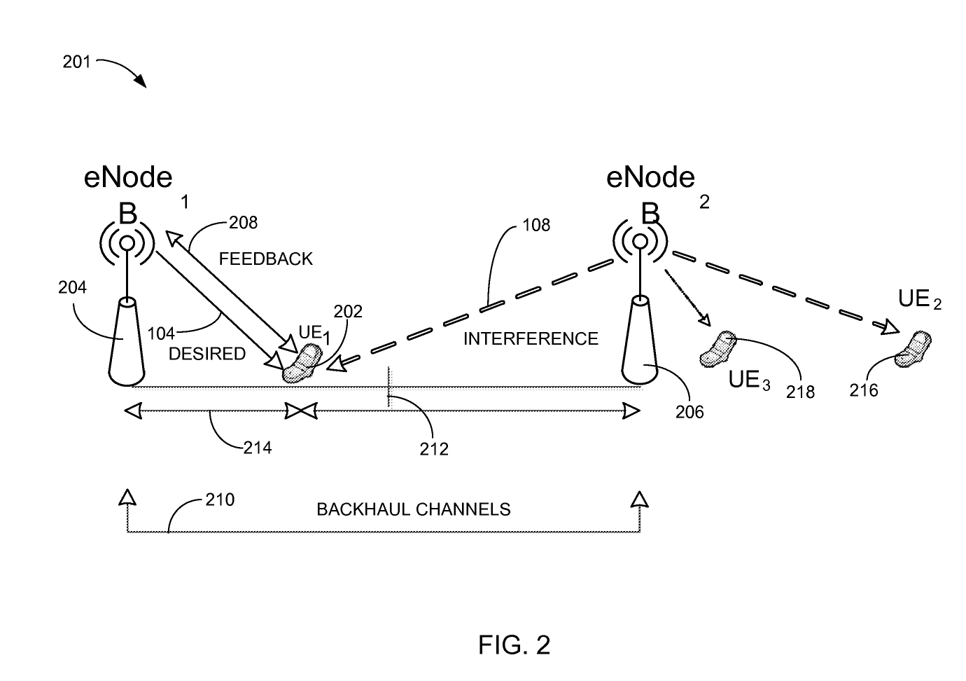

Referring now to FIG. 2, therein is shown a functional block diagram of an application 201 of the wireless communication system 100 of FIG. 1. The functional block diagram of the application 201 depicts a first user electronics 202, such as a cellular telephone, a mobile computer, a personal audio device, or an automotive cellular device, which contains the wireless communication system 100 that is travelling between a serving eNodeB 204 and a neighbor eNodeB 206, such as a geographically adjacent eNodeB.

The serving eNodeB 204 can transmit the desired input signal 104 while the neighbor eNodeB 206 can transmit the interference input signal 108. In most cases the joint iterative detection and decoding module 106 of FIG. 1 can negate the interference input signal 108 without further assistance, but when that is not possible the control processor 112 of FIG. 1 can request additional parametric information 208 from the serving eNodeB 204. The additional parametric information 208 can include parameters such as signal to noise ratio (SNR), signal to interference ratio (SIR), the modulation-and-coding scheme (MCS) of the first user electronics 202, the interference modulation-and-coding scheme (I-MCS), fading channel qualities or any other parameters.

As the first user electronics 202 moves away from the serving eNodeB 204 and toward the neighbor eNodeB 206, the amplitude of the desired input signal 104 can be overridden by the interference input signal 108 from the neighbor eNodeB 206. In such cases, the control processor can request the additional parametric information 208 that includes parametric information from the neighbor eNodeB 206 in order to better track and negate the interference signal 108. The control processor 112 can request the additional parametric information 208 from the serving eNodeB 204.

The serving eNodeB 204 can access a backhaul channel 210 in order to request the additional parametric information 208 related to the neighbor eNodeB 206. The communication between the serving eNodeB 204 and the neighbor eNodeB 206 can occur across the backhaul channel 210, which can be a hard media connection, such as a wired or optical link coupling at least the serving eNodeB 204 and the neighbor eNodeB 206. The backhaul channel 210 can include servers (not shown) that can provide the additional parametric information 208 for any of the neighbor eNodeB 206 in the area of the serving eNodeB 204.

It has been discovered that the control processor 112 can save the additional parametric information 208 of the neighbor eNodeB 206 in preparation for a switch of the serving eNodeB 204 when the first user electronics 202 crosses a transition point 212. The amplitude of the desired input signal 104 can have an inverse relationship to the first distance 214 between the first user electronics 202 and the serving eNodeB 204. When the first user electronics 202 crosses the transition point 212, the control processor 112 can provide the additional parametric information 208 for the neighbor eNodeB 206 to the joint iterative detection and decoding module 106. This preparation step will reduce the possibility of a dropped communication as the first user electronics 202 transitions to the neighbor eNodeB 206, that services a second user electronics 216 and a third user electronics 218, as the new cell site for the serving eNodeB 204.

It will be understood that the occurrence of dropped communication is further reduced by the additional parametric information 208 of the previously linked cell site which can be used to negate the interference input signal 108 as the previously linked cell site becomes the neighbor eNodeB 206 after the switch is executed. It is further understood that the majority of dropped communication in today's wireless networks can occur as a result of the previously described switch between the serving eNodeB 204 and the neighbor eNodeB 206 without the benefit of the additional parametric information 208.

It has been discovered that the wireless communication system and device of the present invention furnishes important and heretofore unknown and unavailable solutions, capabilities, and functional aspects for maintaining the integrity of a wireless communication through switching of cell sites as a result of the serving eNodeB 204 becoming the neighbor eNodeB 206 when the first user electronics 202 passes the transition point 212.

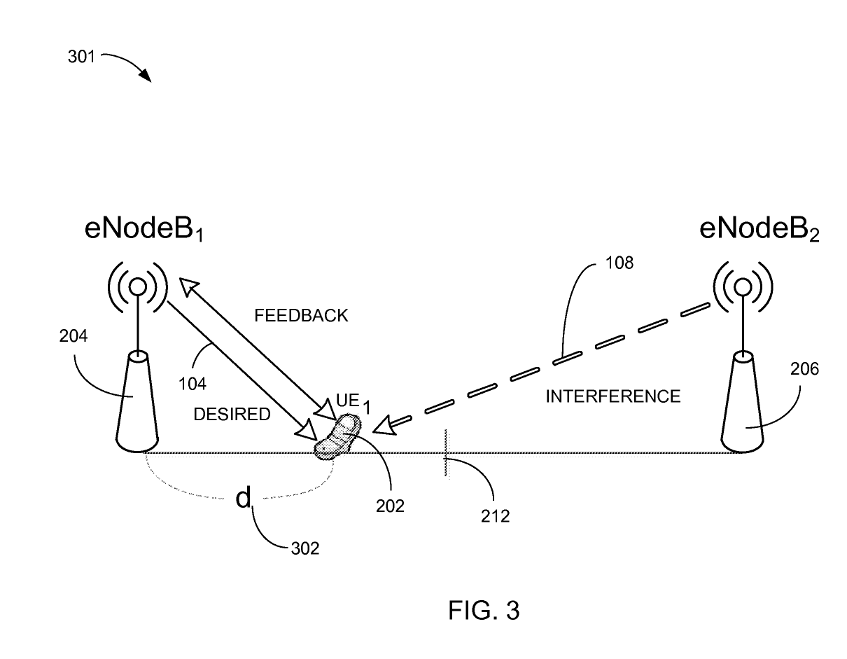

Referring now to FIG. 3, therein is shown a functional block diagram of an application 301 of the wireless communication system 100 of FIG. 1 utilizing the joint iterative detection and decoding 106 of FIG. 1. The functional block diagram of the application 301 depicts the first user equipment 202 receiving the desired input signal 104 from a serving eNodeB 204, such as a first eNodeB, a wireless base station, a communication transceiver, or a wireless hot spot. The first user equipment 202 is depicted as a cell phone but this is by way of an example. The first user equipment 202 can be a mobile computer, an automobile, or a personal communication device.

The neighbor eNodeB 206 can transmit the interference input signal 108 that is unintentionally received by the first user equipment 202. As the first user equipment 202 moves toward the neighbor eNodeB 206 the strength of the desired input signal 104 can be reduced in amplitude as a function of the distance 302 from the serving eNodeB 204, while the interference input signal 108 is increasing.

It has been discovered that the wireless communication system 100 can provide a minimum of 7 dB increase in signal to noise ratio at 1% packet error rate. The resultant reduction in switching between the serving eNodeB 204 and the neighbor eNodeB 206 provides a higher probability that the communication flow will not be interrupted. When the first user electronics 202 passes the threshold point 212, a switch between the serving eNodeB 204 and the neighbor eNodeB 206 occurs, the first user equipment 202 will be much closer to the neighbor eNodeB 206 and the first user equipment 202 will receive a stronger signal. This is primarily due to the fact that the amplitude of the desired input signal is inversely proportional to the distance 302 squared.

It has further been discovered that, as the switch between cell sites occurs, the context and strength of the desired input signal 104 and the interference input signal 108 is reversed. By anticipating that relationship, the wireless communication system 100 can prevent the occurrence of interrupted communication due to the switch of context between the serving eNodeB 204 and the neighbor eNodeB 206.

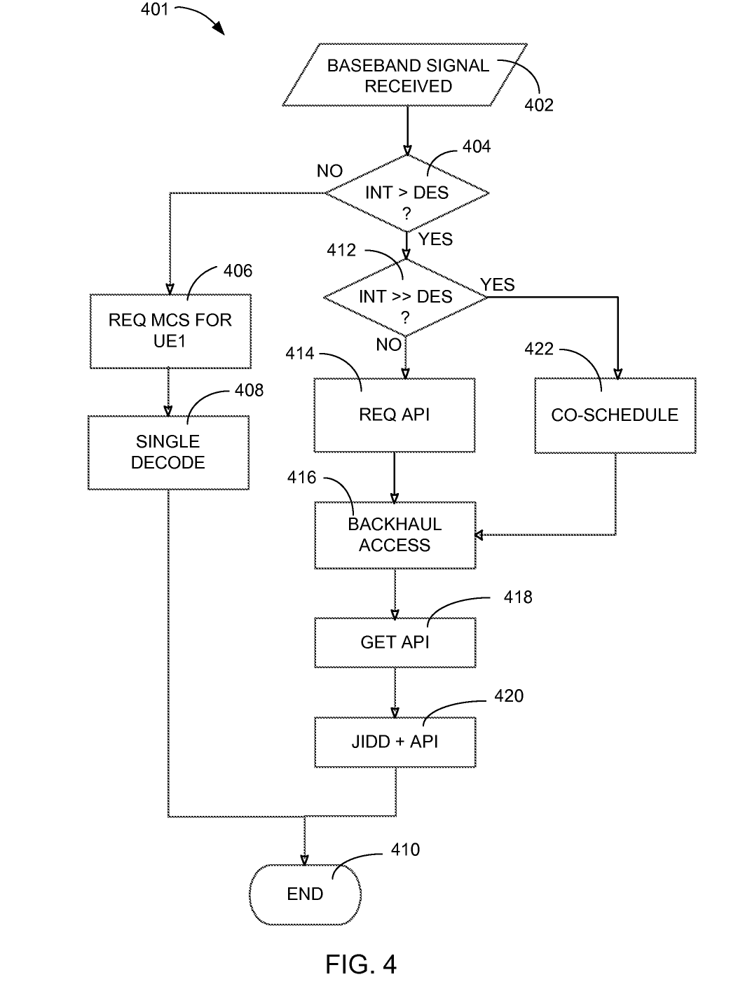

Referring now to FIG. 4, therein is shown a flow chart of a method 401 of operation of the wireless communication system 100 of FIG. 1. The flow chart of the method 401 depicts a receiving module 402, in which the first user electronics 202 of FIG. 2 receives the baseband signals by the wireless interface 102 of FIG. 1.

The flow then proceeds to a compare amplitude module 404 to process the baseband signal by comparing the amplitudes of the desired input signal 104 of FIG. 1 and the interference input signal 108 of FIG. 1. If it is determined that the interference input signal 108 is not of greater amplitude than the desires input signal 104, the flow proceeds to a request the modulation-and-coding scheme module 406.

The request the modulation-and-coding scheme module 406 provides a request from the control processor 112 of FIG. 1 to the serving eNodeB 204 of FIG. 2 to determine the modulation-and-coding scheme (MCS) used by the serving eNodeB 204. The utilization of the MCS of the serving eNodeB 204 allows an enhancement of the desired input signal and can provide an additional 7 dB of signal margin at the lowest data rate. The flow then proceeds to a single decode module 408.

The single decode module 408 can perform the decode of the communication information contained within the desired input signal 104. This process is the normal flow when the first user electronics 202 is closer to the serving eNodeB 204 than the neighbor eNodeB 206 of FIG. 2. The processing of each communication packet will proceed to an end module 410 in preparation for receiving the next broadband signals by the wireless interface 102.

If the compare amplitude module 404 determines that the interference input signal 108 is of greater amplitude than the desired input signal 104, the flow proceeds to a check for greater interference module 412. The check for greater interference module 412 can compare the amplitudes of the desired input signal 104 and the interference input signal 108 to determine whether there is sufficient amplitude of the desired input signal 104 to overcome the interference input signal 108. If the check for greater interference module 412 determines that there is not too much of the interference input signal 108 to be overcome, the flow proceeds to a request additional parametric information module 414.

In the request additional parametric information module 414, the control processor 112 can solicit the first eNodeB 204 for the parameters required to decode the contents of the desired input signal 104. The additional parametric information 208 of FIG. 2 can include parameters such as signal to noise ratio (SNR), signal to interference ratio (SIR), the modulation-and-coding scheme (MCS) of the first user electronics 202, the interference modulation-and-coding scheme (I-MCS), or fading channel qualities. The control processor 112 can specify the modulation-and-coding scheme range or threshold that could be of help for jointly decoding the desired input signal 104. The request additional parametric information module 414 causes the serving eNodeB 204 to analyze the request and if required the serving eNodeB 204 can communicate with the neighbor eNodeB 206 to retrieve the additional parametric information 208.

The flow then proceeds to a backhaul access module 416, in which the response to the solicitation for the additional parametric information 208 to the serving eNodeB 204 causes the serving eNodeB 204 to access the backhaul channels 210 of FIG. 2 in order to retrieve the additional parametric information 208 from the neighbor eNodeB 206. If the interference modulation-and-coding scheme obtained from the neighbor eNodeB 206 is out of the range specified by the first user electronics 202, the serving eNodeB 204 will not forward the interference information, but will instead reduce the control signaling overhead of the wireless interface 102.

This action can allow the first user electronics 202 to use single-user decoding. By retrieving the interference modulation-and-coding scheme and other parametric information, the serving eNodeB 204 can allow the flow to proceed to a get additional parametric information module 418.

In the get additional parametric information module 418, the serving eNodeB 204 can transfer the additional parametric information 208 through the wireless interface 102 to the control processor 112. The control processor 112 can compile the additional parametric information 208 in order to best assist the joint iterative detection and decoding module 106 of FIG. 1. If the additional parametric information 208 retrieved from the neighbor eNodeB 206 is beyond the threshold previously indicated by the control processor 112, the response from the serving eNodeB 204 can indicate the overhead of the wireless interface 102 has been reduced and the joint iterative detection and decoding 106 can revert to a single-user decoding. The flow then proceeds to an assisted decode module 420.

In the assisted decode module 420, the joint iterative detection and decoding module 106 can use the additional parametric information 208 in order to both enhance the desired input signal 104 and negate the interference input signal 108. When the combination provides a powerful decoding tool that maintains the integrity of the wireless communication. The parameter storage module 114 of FIG. 1 can be prepared for the progress of the first user electronics 202 to the transition point 212 of FIG. 2. The control processor 112 can swap the parameters in the joint iterative detection and decoding module 106 in order to maintain full control of the wireless communication during the switch between cell sites. The flow then proceeds to the end module 410.

If the check for greater interference module 412 determines that there is too much of the interference input signal 108 to be overcome, the flow proceeds to a request co-schedule module 422. In the request co-schedule module 422 the control processor 112 can request an allocated slot of time in order to complete the communication transfer while the major interference source is paused in order to minimize the interference input signal 108. This option can provide the best solution to mutual interference situations for the first eNodeB 204 that is encroaching the transition point 212. It is understood that the transition point represents the weakest amplitude of the desired input signal 104 and the strongest amplitude of the interference input signal 108.

The flow then proceeds to the backhaul access module 416 in order to convey the co-scheduling request to the neighbor eNodeB 206. The process flow will proceed to the get additional parametric information module 418. In this instance the serving eNodeB 204 can convey all of the requested parametric information as well as the co-schedule timing for coordinating the wireless communication. The flow proceeds to the assisted decode module 420 as described above and finishes at the end module 410.

It has been discovered that the first user electronics 202 can determines which algorithms are proper in current environment. The choices of a single-user decoding algorithm, only exploiting interference channels, a joint detection algorithm, using both interference modulation and channels, and a joint decoding algorithm using both interference MCS and channels. Depending on the quality/strength of measured parameters, each algorithm could outperform others at specific situation. If the first user electronics 202 determines that joint detection algorithm is preferred at the moment, it requests the serving eNodeB 204 to gain the corresponding interference signal information, i.e., modulation or MCS, from the neighbor eNodeB 206 via the backhaul channels 210.

Explicitly, the serving eNodeB 204 delivers the additional parametric information 208, obtained from the neighbor eNodeB 206, to the first user electronics 202 through the wireless interface 102, and let the first user electronics 202 perform the joint detection algorithm for the desired input signal 104. Once the joint algorithm is selected for use, this scenario fully takes advantage of the backhaul channels 210, between the serving eNodeB 204 and the neighbor eNodeB 206, for providing parametric resources between the serving eNodeB 204 and the first user electronics 202.

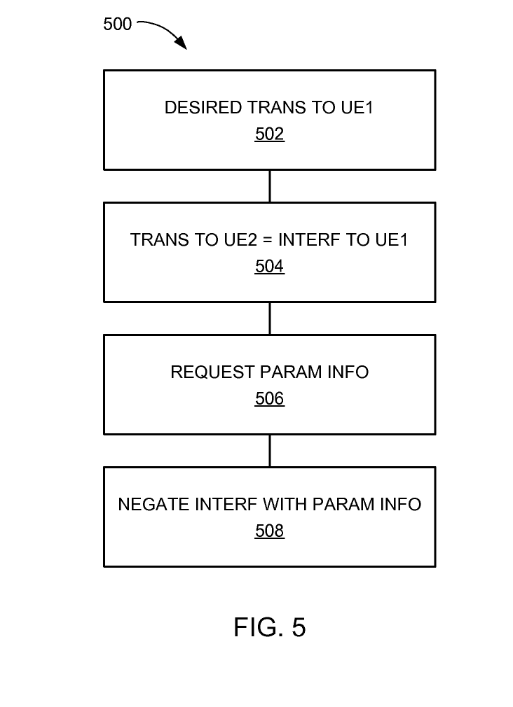

Referring now to FIG. 5, therein is shown a flow chart of a method 500 of operation of the wireless communication system 100 of FIG. 1 in a further embodiment of the present invention. The method 500 includes: transmitting from a serving eNodeB for conveying a desired input signal to a first user electronics in a block 502; transmitting from a neighbor eNodeB for conveying the desired input signal to a second user electronics and broadcasting an interference input signal toward the first user electronics in a block 504; activating a request additional parametric information module in the serving eNodeB for responding to the first user electronics in a block 506; and transferring additional parametric information from the serving eNodeB for negating the interference input signal in the first user electronics in a block 508.

The resulting method, process, apparatus, device, product, and system is straightforward, cost-effective, uncomplicated, highly versatile and effective, can be surprisingly and unobviously implemented by adapting known technologies, and are thus readily suited for efficiently and economically manufacturing wireless communication systems fully compatible with conventional processes and technologies. The resulting method, process, apparatus, device, product, and system is straightforward, cost-effective, uncomplicated, highly versatile, accurate, sensitive, and effective, and can be implemented by adapting known components for ready, efficient, and economical application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a wireless communication system comprising:
transmitting from a serving eNodeB for conveying a desired input signal to a first user electronics;
transmitting from a neighbor eNodeB for conveying the desired input signal to a second user electronics and broadcasting an interference input signal toward the first user electronics;
activating a request additional parametric information module in the serving eNodeB for responding to the first user electronics; and
transferring additional parametric information from the serving eNodeB for negating the interference input signal in the first user electronics.

2. The method as claimed in claim 1 further comprising coupling backhaul channels between the serving eNodeB and the neighbor eNodeB for collecting the additional parametric information.

3. The method as claimed in claim 1 wherein activating the request additional parametric information module for the first user electronics includes accessing a wireless interface in the first user electronics for requesting the additional parametric information from the serving eNodeB.

4. The method as claimed in claim 1 further comprising:
executing a co-scheduling module between the serving eNodeB and the neighbor eNodeB; and
executing a get additional parametric information module for conveying the additional parametric information from the co-scheduling module to the first user electronics.

5. The method as claimed in claim 1 wherein transferring the additional parametric information includes:
receiving, by a control processor, the additional parametric information; and
configuring a joint iterative detection and decoding module with the additional parametric information for negating the interference input signal.

6. A method of operation of a wireless communication system comprising:
transmitting from a serving eNodeB for conveying a desired input signal to a first user electronics;
transmitting from a neighbor eNodeB for conveying the desired input signal to a second user electronics and broadcasting an interference input signal toward the first user electronics for communicating with the second user electronics;
activating a request additional parametric information module in the serving eNodeB for responding to the first user electronics; and
transferring additional parametric information from the serving eNodeB for negating the interference input signal in the first user electronics including saving the additional parametric information for the first user electronics for preventing a dropped communication at a transition point between the serving eNodeB and the neighbor eNodeB.

7. The method as claimed in claim 6 further comprising coupling backhaul channels between the serving eNodeB and the neighbor eNodeB for collecting the additional parametric information including requesting a threshold for the additional parametric information for negating the interference input signal.

8. The method as claimed in claim 6 wherein activating the request additional parametric information module by the first user electronics includes accessing a wireless interface in the first user electronics for requesting the additional parametric information from the serving eNodeB including initiating a backhaul access module between the serving eNodeB and the neighbor eNodeB.

9. The method as claimed in claim 6 further comprising:
executing a co-scheduling module between the serving eNodeB and the neighbor eNodeB including communicating through backhaul channels; and
executing a get additional parametric information module for conveying the additional parametric information from the co-scheduling module to the first user electronics including communicating through a wireless interface.

10. The method as claimed in claim 6 wherein transferring the additional parametric information includes:
activating a wireless interface for the first user electronics for communicating by the serving eNodeB;
receiving, by a control processor, the additional parametric information; and
configuring a joint iterative detection and decoding module with the additional parametric information for negating the interference input signal.

11. A wireless communication system comprising:
a serving eNodeB for conveying a desired input signal;
a neighbor eNodeB for broadcasting an interference input signal toward the serving eNodeB; and
a request additional parametric information module in the serving eNodeB activated for receiving the desired input signal and the interference input signal includes additional parametric information transferred from the serving eNodeB for negating the interference input signal in a first user electronics.

12. The system as claimed in claim 11 further comprising backhaul channels between the serving eNodeB and the neighbor eNodeB for collecting the additional parametric information.

13. The system as claimed in claim 11 wherein the request additional parametric information module activated for first user electronics includes a wireless interface for requesting the additional parametric information from the serving eNodeB.

14. The system as claimed in claim 11 further comprising:
a co-scheduling module activated between the serving eNodeB and the neighbor eNodeB; and
a get additional parametric information module executed for conveying the additional parametric information from the co-scheduling module to the first user electronics.

15. The system as claimed in claim 11 further comprising a get additional parametric information module for the first user electronics includes:
a control processor for receiving the additional parametric information; and
a joint iterative detection and decoding module configured with the additional parametric information for negating the interference input signal.

16. The system as claimed in claim 11 further comprising a transition point between the serving eNodeB and the neighbor eNodeB; and
wherein:
the first user electronics includes a parameter storage module for saving the additional parametric information and preventing a dropped communication at the transition point.

17. The system as claimed in claim 16 further comprising backhaul channels between the serving eNodeB and the neighbor eNodeB for collecting the additional parametric information; and
wherein:
the first user electronics includes a control processor for establishing a threshold for the additional parametric information and negating the interference input signal.

18. The system as claimed in claim 16 wherein the serving eNodeB provides the additional parametric information for the first user electronics includes a wireless interface for requesting the additional parametric information.

19. The system as claimed in claim 16 further comprising:
a co-scheduling module executed through backhaul channels between the serving eNodeB and the neighbor eNodeB; and
a get additional parametric information module executed in the serving eNodeB for conveying the additional parametric information from the co-scheduling module to the first user electronics.

20. The system as claimed in claim 16 further comprising a get additional parametric information module for the first user electronics includes:
a wireless interface for communicating with the serving eNodeB;
a control processor for receiving the additional parametric information; and
a joint iterative detection and decoding module configured with the additional parametric information for negating the interference input signal.
